(19) United States
(12) Patent Application Publication
(10) Pub. No.: US 2011/0116634 A1
(43) Pub. Date: May 19, 2011

(54) METHOD AND SYSTEM FOR INSTALLING SOUND SETS ON ELECTRONIC INSTRUMENTS

(75) Inventor: James Norman, Rancho Park, CA (US)

(73) Assignee: ION AUDIO, LLC., Cumberland, RI (US)

(21) Appl. No.: 12/948,315

(22) Filed: Nov. 17, 2010

Related U.S. Application Data
(60) Provisional application No. 61/261,950, filed on Nov. 17, 2009.

(51) Int. Cl. H04L 9/00; G10H 3/00; G10D 13/02

(52) U.S. Cl. 380/277; 84/723; 84/411 R

(57) ABSTRACT

A method and system of installing a sound set on an electronic instrument is disclosed. The method and system includes an electronic instrument having a serial number, a sound set having a plurality of sampled sounds, and an encrypted key having a matching serial number and a signature of the sound set. A first step includes comparing the serial number of the electronic instrument with the serial number stored in the encrypted key to ensure they match. A second step includes comparing the signature of the encrypted key and the sound set. A fourth step includes installing the sound set on the electronic instrument only if the signature matches the sound set and the matching serial number matches the serial number of the electronic instrument.

### CROSS-REFERENCE TO RELATED APPLICATION

The present patent document claims priority to earlier filed U.S. Provisional Patent Application Ser. No. 61/261,950, filed on Nov. 17, 2009, the entire contents of which are incorporated herein by reference.

### BACKGROUND OF THE INVENTION

1. Field of the Invention

The present patent document relates generally to electronic music instruments and more particularly to a method and system of installing sound sets on electronic instruments, such as synthesizers and electronic drum sets.

2. Background of the Related Art

Musicians desire to have the ability load custom sound sets of electronic drum or synthesizer sounds from their computer and onto the existing electronic instrument, such as a synthesizer of electronic drum module. These sound sets are created by mostly existing third party companies that specialize in making drum sounds that can only be played on computers. These sound sets, though, are not usable on electronic instruments. Many electronic instruments include sound sets stored on a non-changeable ROM.

Electronic instruments suffer from a couple of disadvantages. First, the sound sets that are stored by the manufacturer often lack expressivity or uniqueness that is desired by the musician. Second, because the electronic instruments store sound sets in a ROM the prior art lacks an ability to change the internal sound set for another sound set that the user or musician would prefer.

Although the prior art has attempted to solve this problem by providing sound modules as a hardware expansion, such as removable ROMs, this solution is expensive and does not permit the user or musician to use the same sound set on his or her computer.

Therefore, there is a perceived need in the art for a method and system of installing sound sets onto electronic instruments that is convenient, easy and inexpensive for consumers and musicians.

### SUMMARY OF THE INVENTION

The present invention solves the problems of the prior art by providing a capability to make the sound sets portable so that the customer or musician can play the sounds they like on their computer on an electronic instrument. Specifically, users and musicians that desire more variety of sounds to load into their synthesizer or drum sound module via the computer.

The present invention does not require a hardware installation of sound sets because the sound sets may be installed via a high speed data interface onto the electronic instrument.

Also, the entire sound set, kit parameters, instrument parameters, and patterns are loaded into the electronic instrument at the same time, which eliminates the need for the user to re-program the electronic instrument when loading new data.

### BRIEF DESCRIPTION OF THE DRAWINGS

These and other features, aspects, and advantages of the present invention will become better understood with reference to the following description and accompanying drawings where:

FIG. 1 is a front view of an embodiment of the method and system of the present invention implemented in an electronic drum kit with a drum module connected thereto;

FIG. 2 is a perspective view of the electronic drum module;

FIG. 3 top view of the electronic drum module;

FIG. 4 is a rear view of the electronic drum module; and

FIG. 5 is a block diagram of the preferred embodiment of the method and system for installing sound sets on electronic instruments of the present invention.

### DESCRIPTION OF THE PREFERRED EMBODIMENT

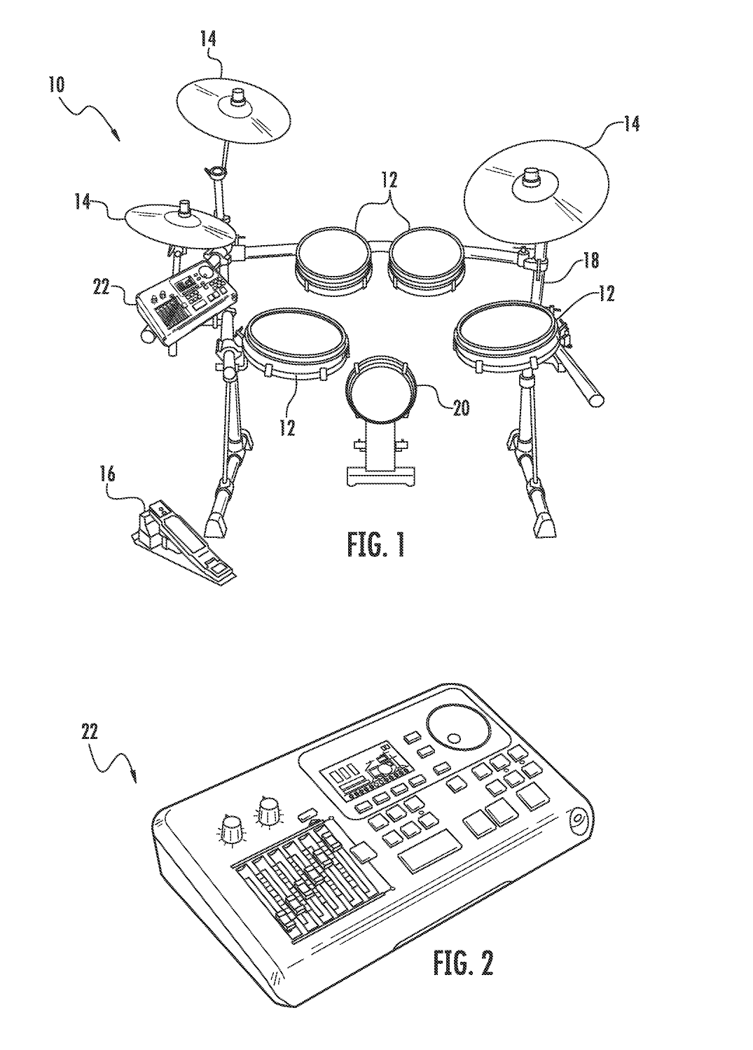

Referring now to FIG. 1, an electronic drum kit including an electronic drum module that embodies the method and system for installing sound sets on electronic instruments of the present invention is shown generally at 10. The electronic drum kit 10 may include several electronic drum pads 12, electronic cymbals 14 and even an electronic Hi Hat foot pedal 16 for simulating Hi Hat cymbals. These are connected on support frame 18 that permits adjustment of the position and orientation of each instrument 12, 14 to the user's preferences. The drum kit 10 may also include a separate bass drum pad 20 as well. Although the invention will be described with reference to a drum kit 10, one skilled in the art would find that the concepts of the present invention may be applied to other electronic instruments, such as synthesizers, as well.

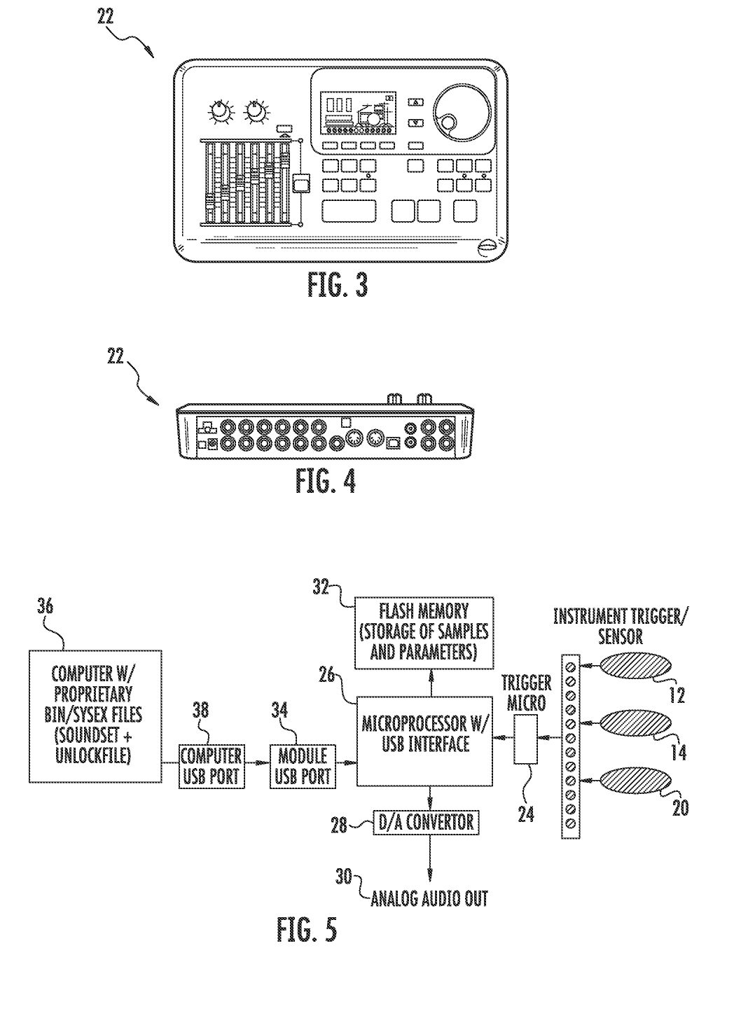

Each of the drums 12, 20 and cymbals 14, 16 includes a sensor (such as a Piezo transducer) which is configured to send an electronic signal in response to the drum pad 12 or cymbal being 14, 16 struck (or played) by the musician. The drums 12, 20 and cymbals 14, 16 are individually connected to an electronic drum module 22 (best seen in FIGS. 2-4).

Turning now to FIG. 5, the electronic drum module 22 generates the electronic audio signal for each electronic instrument 12, 14, 16, 20. Specifically, the electronic drum module 22 includes PCM sampled sounds stored in sound sets that are played in response signals received from the sensors in each of the electronic instruments 12, 14, 16, 20. Electronic signals from the drums 12, 20 and cymbals 14, 16 are first processed through a trigger processor 24, which essentially converts the analog signals into a digital signal. This digital signal is transmitted to the microprocessor 26 in the drum module 22. The microprocessor 26 receives the digital signal and selects the appropriate sampled sound from the PCM samples stored in the sound set to play. The played PCM sample is converted to an analog signal by a digital-to-analog converter 28 and transmitted through the analog audio output 30.

All the PCM samples are stored in a sound set on the flash memory 32 inside the electronic drum module 22. The electronic drum module 22 includes a high speed data interface 34, such as a universal serial bus, that is connected to the microprocessor 26. Because this flash memory 32 can be overwritten, the user can send a proprietary compiled file created on a personal computer 36 to the electronic drum module 22 and the flash memory 32 thereon, which is discussed further below.

Each of these compiled sound set files can be customized with specific versions of “.wav” files and programming information for the drum module 22 to use as internal sound data.

Furthermore, the drum module 22 includes copy protection so the PCM samples in the sound set cannot be used in a drum module 22 that it was not intended for. The copy protection is achieved by burning a serial number into a section of the flash memory 32 permanently. In addition to the sound set, there is an encrypted MIDI SYSEX file that includes this serial number along with an encrypted signature (or fingerprint) of the particular sound set. The SYSEX file is loaded into the drum module 22 via the high speed data interface 38 from a personal computer 36. If the drum module's 22 serial number matches that of the serial contained in the encrypted SYSEX file, the drum module 22 will allow download of that particular sound set into the flash memory 32. If the serial numbers do not match, the download will not be permitted.

Therefore, it can be seen that the present invention provides a unique solution to the problem of providing a method and system for downloading custom sound sets onto an electronic instrument, such as an electronic drum module.

It would be appreciated by those skilled in the art that various changes and modifications can be made to the illustrated embodiments without departing from the spirit of the present invention, such as using synthesizers or other electronic instruments. All such modifications and changes are intended to be within the scope of the present invention.

What is claimed is:

1. A method of installing a sound set on an electronic instrument, comprising:
providing an electronic instrument having a serial number;
providing a sound set having a plurality of sampled sounds;
providing an encrypted key having a matching serial number and a signature of the sound set;
comparing the serial number of the electronic instrument with the serial number stored in the encrypted key to ensure they match;
comparing the signature of the encrypted key and the sound set; and
installing the sound set on the electronic instrument only if the signature matches the sound set and the matching serial number matches the serial number of the electronic instrument.

2. The method of claim 1, further comprising encoding the encrypted key as a MIDI SYSEX file.

3. The method of claim 1, further comprising writing the serial number permanently into a memory of the electronic instrument.

4. The method of claim 1, wherein the electronic instrument provided includes an electronic drum module.

5. A system for installing a sound set on an electronic instrument, comprising:
an electronic instrument having a memory and a serial number;
a sound set having a plurality of sampled sounds;
an encrypted key having a matching serial number and a signature of the sound set;
a computer connected to the electronic instrument and configured and arranged to compare the serial number of the electronic instrument with the serial number stored in the encrypted key to ensure they match;
the computer further configured and arranged to compare the signature of the encrypted key and the sound set; and
the computer further configured and arranged to install the sound set on the electronic instrument only if the signature matches the sound set and the matching serial number matches the serial number of the electronic instrument.

6. The system of claim 5, wherein said encrypted key is encoded as a MIDI SYSEX file.

7. The system of claim 5, wherein the serial number is permanently written into the memory of the electronic instrument.

8. The method of claim 5, wherein the electronic instrument provided includes an electronic drum module.

9. An electronic drum module, comprising:
a plurality of connectors configured and arranged to be connected to a plurality of instrument triggers;
a memory;
a serial number;
a sound set having a plurality of sound samples stored in the memory;
an encrypted key with a matching serial number that matches the serial number and a signature of the sampled sounds of the sound set; and
a microprocessor configured and arranged to detect a strike against any of the plurality of instrument triggers through the connectors and play a sampled sound from the sound set stored in the memory responsive to the strike.

10. The electronic drum module of claim 9, wherein said microprocessor is further configured and arranged to compare the matching serial number of the encrypted key to the serial number to ensure a match.

11. The electronic drum module of claim 9, wherein said microprocessor is further configured and arranged to compare the signature of the encrypted key to the sound samples of the sound set to ensure a match.

12. The electronic drum module of claim 11, wherein said plurality of instrument triggers includes at least one electronic cymbal.

13. The electronic drum module of claim 11, wherein said plurality of instrument triggers includes at least one electronic drum pad.

14. The electronic drum module of claim 11, wherein said serial number is stored in said memory.

15. An electronic drum kit, comprising:
an electronic drum module;
a plurality of instrument triggers connected to said drum module;
said electronic drum module having a memory and a serial number;
a sound set having a plurality of sound samples configured and arranged to be stored in the memory of the electronic drum module;
an encrypted key with a matching serial number and a signature of the sound set stored therein;
said electronic drum module configured an arranged to store the sound set in the memory provided the serial number matches the matching serial number in the encrypted key encrypted and the signature matches the sampled sounds in the sound set; and
said electronic drum module configured and arranged to detect a strike against any of the plurality of instrument triggers and play a sampled sound from the sound set responsive to the strike.

16. The electronic drum kit of claim 15, wherein said plurality of instrument triggers includes at least one electronic cymbal.

17. The electronic drum kit of claim 15, wherein said plurality of instrument triggers includes at least one electronic drum pad.

18. The electronic drum kit of claim 15, wherein said serial number is stored in said memory.

19. A copy-protected sound set for an electronic instrument, comprising:
a plurality of PCM sampled sounds stored in a computer-readable medium; and
an encrypted key including a serial number portion and a signature portion stored in a computer-readable medium;
said signature portion formed from the attributes of the PCM sampled sounds and said serial number portion being paired with a specific electronic instrument.

20. The sound set of claim 19, wherein said specific electronic instrument is a specific electronic drum module.

21. The sound set of claim 19, wherein said encrypted key is encoded as a MIDI SYSEX file.
